(19) United States
(12) Patent Application Publication
(10) Pub. No.: US 2023/0387793 A1
(43) Pub. Date: Nov. 30, 2023

(54) CONTROL CIRCUIT, POWER FACTOR CORRECTION CIRCUIT, AND ELECTRIC APPLIANCE

(71) Applicant: Rohm Co., Ltd., Kyoto (JP)

(72) Inventors: Manae ITO, Kyoto (JP); Satoshi MAEJIMA, Kyoto (JP)

(21) Appl. No.: 18/315,992

(22) Filed: May 11, 2023

(30) Foreign Application Priority Data
May 27, 2022 (JP) 2022-086744

(51) Int. Cl. H02M 1/42; H02M 3/158; H02M 1/08; H02M 7/217

(52) U.S. Cl. CPC H02M 1/4208; H02M 3/158; H02M 1/08; H02M 7/217

(57) ABSTRACT

A control circuit controls a power factor correction circuit including a DC-DC converter. The control circuit includes an amplifier configured to amplify a voltage commensurate with the output voltage of the DC-DC converter, a comparator configured to compare the output voltage of the amplifier with a slope voltage commensurate with the current passing through a switching element in the DC-DC converter, and a driver configured to drive the switching element based on the output voltage of the comparator. The control circuit is configured to adjust at least one of the gain of the amplifier and the gradient of the slope voltage in accordance with the load power of the DC-DC converter.

This nonprovisional application claims priority under 35 U.S.C. § 119(a) on Patent Application No. 2022-086744 filed in Japan on May 27, 2022, the entire contents of which are hereby incorporated by reference.

### BACKGROUND OF THE INVENTION

### Field of the Invention

The invention disclosed herein relates to a control circuit as well as to a power factor correction circuit and an electric appliance employing such a control circuit.

### Description of Related Art

A power factor correction circuit monitors the alternating-current input voltage and the alternating-current input current to a power supply device that performs AC-DC (alternating-current to direct-current) conversion and keeps them substantially in phase with each other so as to keep the power factor close to one (that is, 100%).

Distortion in the alternating-current input current is represented by total harmonic distortion (THD). High THD can cause power failure, and this may adversely affect devices other than the electronic appliance incorporating the power factor correction circuit. For this reason, power factor correction circuits are expected to operate with low THD.

With the control circuit for a power factor correction circuit disclosed in Japanese Unexamined Patent Application published as No. 2022-060692, it is possible to suppress THD. However, generally, a PFC circuit, under a light load, performs operation (burst operation) to suspend switching operation of the switching element to suppress an rise in the output voltage under a light load.

During the burst operation, the alternating-current input current is zero, resulting in high THD. Thus, with the control circuit for a power factor correction circuit disclosed in Japanese Unexamined Patent Application published as No. 2022-060692, it is not possible to keep THD low during low power output.

### SUMMARY OF THE INVENTION

According to one aspect of what is disclosed herein, a control circuit controls a power factor correction circuit including a DC-DC converter. The control circuit includes an amplifier configured to amplify a voltage commensurate with the output voltage of the DC-DC converter, a comparator configured to compare the output voltage of the amplifier with a slope voltage commensurate with the current passing through a switching element in the DC-DC converter, and a driver configured to drive the switching element based on the output voltage of the comparator. The control circuit is configured to adjust at least one of the gain of the amplifier and the gradient of the slope voltage in accordance with the load power of the DC-DC converter.

According to another aspect of what is disclosed herein, a power factor correction circuit includes the control circuit configured as described above and the DC-DC converter.

According to yet another aspect of what is disclosed herein, an electric appliance includes a rectification circuit configured to perform full-wave rectification on an alternating-current voltage and the power factor correction circuit configured as described above that is configured to receive the output voltage of the rectification circuit.

According to the invention disclosed herein, it is possible to keep THD low when a power factor correction circuit outputs low electric power. The significance and effects of the present invention will be further clarified by the description of embodiments below. It should be understood that the following embodiments are merely examples of how the present invention can be implemented, and thus the senses of the terms used to describe the present invention and its constituent elements are not limited in any way to those in which they are used in the following description of embodiments.

### BRIEF DESCRIPTION OF THE DRAWINGS

FIG. 1 is a diagram showing a configuration of an electric appliance according to one embodiment.

FIG. 2 is a diagram showing one example of a power factor correction circuit.

FIG. 3 is a diagram showing a configuration of a first conversion circuit.

FIG. 4 is a diagram showing a configuration of a second conversion circuit.

FIG. 5 is a diagram showing a configuration of a current calculator and the like.

FIG. 6 is a timing chart showing relevant voltage waveforms in an IC having a calculation circuit according to a first configuration example.

FIG. 7 is a diagram showing a part of a calculation circuit according to a second configuration example.

FIG. 8 is a diagram showing the gain characteristics of the calculation circuit according to the second configuration example.

FIG. 9 is a diagram showing a part of a calculation circuit according to a third configuration example.

FIG. 10 is a diagram showing the gain characteristics of the calculation circuit according to the third configuration example.

### DETAILED DESCRIPTION OF PREFERRED EMBODIMENTS

In the present description, a MOS (metal-oxide-semiconductor) field-effect transistor denotes a field-effect transistor in which the gate is structured to have at least three layers: a layer of an electrical conductor or of a semiconductor such as polysilicon with a low resistance value, an insulation layer, and a P-type, N-type or intrinsic semiconductor layer. That is, the structure of the gate of a MOS field-effect transistor is not limited to a three-layer structure composed of a metal, an oxide, and a semiconductor.

In the present description, a reference voltage means a voltage that is constant under ideal conditions, and in reality it can vary slightly with change in temperature or the like.

In the present description, a constant voltage means a voltage that is constant under ideal conditions, and in reality it can vary slightly with change in temperature or the like.

<Electronic Appliance>

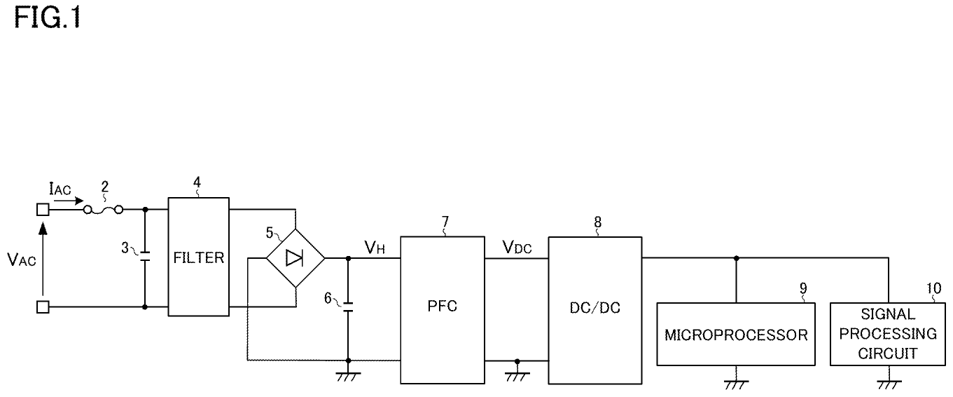

FIG. 1 is a circuit diagram showing a configuration of an electric appliance 1 according to one embodiment. Examples of the electric appliance 1 include, for example, home electric appliances such as a television monitor, a refrigerator, and an air conditioner; a computer and an AC adapter etc. as accessories of a computer. The electric appliance 1 includes a fuse 2, a capacitor 3, a filter 4, a rectification circuit 5, a capacitor 6, and a power factor correction (PFC) circuit 7. The electric appliance 1 further includes a DC-DC converter 8, a microprocessor 9, and a signal processing circuit 10. The electric appliance 1 divides into a primary side and a secondary side that are isolated from each other across, as a boundary, an insulated transformer (not shown) in the DC-DC converter 8.

The rectification circuit 5 is, for example, a rectification circuit configured as a diode bridge. The alternating-current voltage V_{AC} such as a commercial alternating-current voltage V_{AC} is fed to the rectification circuit 5 via the fuse 2, the capacitor 3, and the filter 4. The rectification circuit 5 performs full-wave rectification on the alternating-current voltage V_{AC} to generate a first voltage V_{H}. Thus, the first voltage V_{H} has a full-wave rectified waveform.

The first voltage V_{H} is fed to the PFC circuit 7 via the capacitor 6. The PFC circuit 7 has a boost (step-up) DC-DC converter (switching regulator) that generates an output voltage V_{DC} from the first voltage V_{H}. The PFC circuit 7 improves the power factor by keeping the first voltage V_{H} substantially in phase with the input current I_{AC}.

The DC-DC converter 8 receives the output voltage V_{DC} of the PFC circuit 7 and bucks it to feed the resulting voltage to the microprocessor 9 and to the signal processing circuit which are loads.

The microprocessor 9 controls the whole electric appliance 1 in a centralized manner. The signal processing circuit 10 is a block that performs specific signal processing. Examples include an interface circuit for communication with an external device, an image processing circuit, and a sound processing circuit. Needless to say, in reality, the electric appliance 1 is provided with a plurality of signal processing circuits 10 in accordance with the desired functions.

Thus far is the description of the configuration of the electric appliance 1. In this way, AC-DC conversion is performed by an electric appliance including the rectification circuit that performs full-wave rectification on the alternating-current voltage V_{AC} and the PFC circuit 7 that boosts the full-wave rectified first voltage V_{H} to generate the output voltage V_{DC}

<Power Factor Correction Circuit>

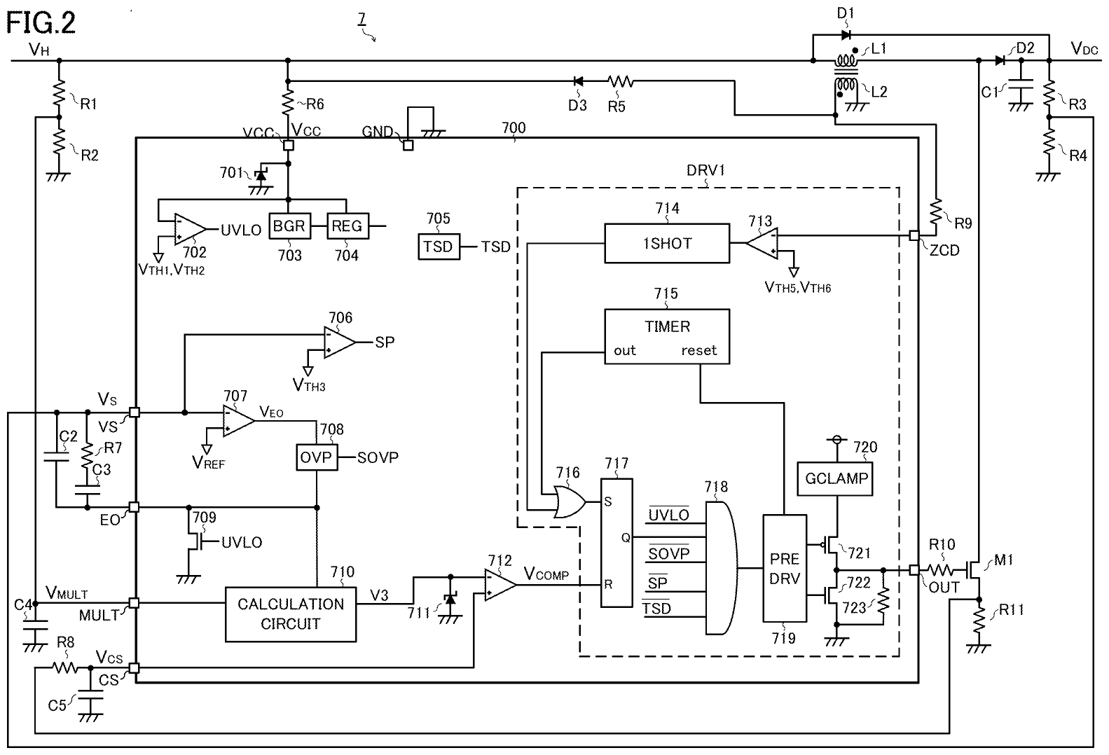

Now, the PFC circuit 7 incorporated in the electric appliance 1 will be described in detail. FIG. 2 is a circuit diagram showing a configuration of the PFC circuit 7 according to one embodiment. As described above, the PFC circuit 7 has a boost DC-DC converter (switching regulator). In a modified version of this embodiment, the PFC circuit 7 may include a DC-DC converter of any type other than the boost type.

The PFC circuit 7 includes an IC (integrated circuit) 700, resistors R1 to R11, capacitors C1 to C5, diodes D1 to D3, inductors L1 and L2, and a switching transistor M1. In this embodiment, the switching transistor M1 is an NMOS (negative-channel MOS) field-effect transistor.

The IC 700 is a control circuit for the PFC circuit 7. The IC 700 has terminals VCC, GND, ZCD, OUT, CS, MULT, EO, and VS.

One terminal of the resistor R1 is fed with the first voltage V_{H}. The other terminal of the resistor R1 is connected to one terminal of the resistor R2, to one terminal of the capacitor C4, and to the terminal MULT. The other terminal of the resistor R2 and the other terminal of the capacitor C4 are connected to a ground potential. With this configuration, an alternating-current voltage V_{MULT} as a voltage resulting from the first voltage V_{H} being divided with the resistors R1 and R2 is fed to the terminal MULT.

One terminal of the resistor R1 is connected to one terminal of the inductor L1 and to the anode of the diode D1. The other terminal of the inductor L1 is connected to the anode of the diode D2 and to the drain of the switching transistor M1. The cathodes of the diodes D1 and D2 are connected to one terminal of the capacitor C1. The other terminal of the capacitor C1 is connected to the ground potential, and the gate of the switching transistor M1 is connected to the terminal OUT via the resistor R10, and the source of the switching transistor M1 is connected to the ground potential via the resistor R11. With this configuration, the PFC circuit 7 has a boost DC-DC converter (switching regulator). The voltage V_{DC} as the output voltage of the boost DC-DC converter (switching regulator) is output from one terminal of the capacitor C1.

The inductors L1 and L2 are magnetically coupled together. One terminal of the inductor L2 is connected to the terminal ZCD via the resistor R9. The other terminal of the inductor L2 is connected to the ground potential. With this configuration, the IC 700 can monitor the voltage fed to the terminal ZCD to detect the zero-crossing of the current that passes through the inductor L1.

One terminal of the resistor R3 is fed with the voltage V_{DC}. The other terminal of the resistor R3 is connected to one terminal of the resistor R4, to one terminal of the capacitor C2, to one terminal of the resistor R7, and to the terminal VS. The other terminal of the resistor R4 is connected to the ground potential. The other terminal of the resistor R7 is connected to one terminal of the capacitor C3. The other terminals of the capacitors C2 and C3 are connected to a terminal EO. With this configuration, a voltage V_{S} as a voltage resulting from the voltage V_{DC} being divided with the resistors R3 and R4 is fed to the terminal VS.

Across the resistor R11 appears a voltage proportional to the current that passes through the switching transistor M1 (i.e., the drain current of the switching transistor M1). The resistor R8, the capacitor C5, and the resistor R11 generate a slope voltage V_{CS} with a gradient reflecting the current that passes through the switching transistor M1, and feed the slope voltage V_{CS} to the terminal CS. The higher the current that passes through the switching transistor M1, the steeper the gradient of the slope voltage V_{CS}.

One terminal of the resistor R5 is connected to one terminal of the inductor L2 and to one terminal of the resistor R9. The other terminal of the resistor R5 is connected to the anode of the diode D3. The cathode of the diode D3 and one terminal of the resistor R6 are fed with the first voltage V_{H}. The other terminal of the resistor R6 is connected to the terminal VCC. The resistor R5, the diode D3, and the resistor R6 generate a supply voltage V_{CC}. The supply voltage V_{CC} is fed to the terminal VCC. The terminal GND is connected to the ground potential.

<Control Circuit>

A more specific configuration of the IC 700 will now be described. The IC 700 includes a Zener diode 701, a comparator 702, a band-gap reference voltage circuit 703, a constant voltage circuit 704, and an overheat protection circuit 705. The anode of the Zener diode 701 is connected to the ground potential, and the cathode of the Zener diode 701 is connected to the terminal VCC.

The Zener diode 701 clamps the supply voltage V_{CC} at the Zener voltage. The inverting input terminal of the comparator 702, the band-gap reference voltage circuit 703, and the constant voltage circuit 704 are connected to the terminal VCC.

The comparator 702 is a hysteresis comparator and compares the supply voltage V_{CC} with a threshold voltage to output an undervoltage lock-out signal UVLO indicating the result of the comparison. If the supply voltage V_{CC} is equal to or higher than the threshold voltage, the undervoltage lock out signal UVLO is at low level (a level indicating a normal state) and, if the supply voltage V_{CC} is lower than the threshold voltage, the undervoltage lock out signal UVLO is at high level (a level indicating a fault state). The threshold voltage used in the comparator 702 shifts between a first threshold voltage V_{HT1} (for example, 8 [V]) and a second threshold voltage V_{TH2} (for example, 13 [V]) in accordance with the level of the undervoltage lock out signal UVLO.

The band-gap reference voltage circuit 703 generates, using the supply voltage V_{CC}, a reference voltage to feed it to the constant voltage circuit 704.

The constant voltage circuit 704 generates, using the supply voltage V_{CC} and the reference voltage, a constant voltage to feed it to different parts of the IC 700.

The overheat protection circuit 705 senses the ambient temperature and, if it is equal to or higher than a threshold temperature, outputs an overheat protection signal TSD at high level (a level indicating a fault state) and, if it is lower than the threshold temperature, outputs an overheat protection signal TSD at low level (a level indicating a normal state).

The IC 700 further includes a comparator 706.

The comparator 706 compares the voltage V_{S} with a third threshold voltage V_{TH3} (for example, 0.3 [V]) and outputs a short-circuit protection signal SP as the result of the comparison. If the voltage V_{S} is equal to or higher than the third threshold voltage V_{TH3}, the short-circuit protection signal SP is at low level (a level indicating a normal state) and, if the voltage V_{S} is lower than the third threshold voltage V_{TH3}, the short-circuit protection signal SP is at high level (a level indicating a fault state).

The IC 700 further includes an error amplifier circuit 707, an overvoltage protection circuit 708, an NMOS field-effect transistor 709, a calculation circuit 710, a Zener diode 711, a comparator 712, and a driving circuit DRV1.

The error amplifier circuit 707 amplifies the difference between the voltage V_{S} commensurate with the output voltage V_{DC} of a boost DC-DC converter (switching regulator) provided in the PFC circuit 7 and a reference voltage V_{REF} to generate a second voltage V_{EO}. Here, the gain of the error amplifier circuit 707 can be one. The error amplifier circuit 707 supplies the second voltage V_{EO} to the terminal EO and to the calculation circuit 710 via the overvoltage protection circuit 708.

The overvoltage protection circuit 708 outputs a static overvoltage protection signal SOVP. The overvoltage protection circuit 708, if the second voltage V_{EO} rises up to a fourth threshold voltage V_{TH4}, keeps the static overvoltage protection SOVP at high level (a level indicating a fault state) until the second voltage V_{EO} falls down to a constant voltage V_{BURST} and otherwise keeps the static overvoltage protection SOVP at low level (a level indicating a normal state). While the static overvoltage protection SOVP is at high level, the IC 700 performs operation (burst operation) to suspend the switching operation of the switching transistor M1.

The gate of the NMOS field-effect transistor 709 is fed with the undervoltage lock out signal UVLO. The drain of the NMOS field-effect transistor 709 is connected the terminal EO, and the source of the NMOS field-effect transistor 709 is connected to the ground potential. The NMOS field-effect transistor 709 is a switch for discharging the second voltage V_{EO} fed to the terminal EQ. Thus, if the undervoltage lock out signal UVLO is at low level, the NMOS field-effect transistor 709 is on so that the second voltage V_{EO} falls.

The calculation circuit 710 generates a third voltage V3 commensurate with the alternating-current voltage V_{MULT} and the second voltage V_{EO}. The second voltage V_{EO} is a voltage commensurate with the voltage V_{S} and hence with the voltage V_{DC}. Thus, the calculation circuit 710 generates the third voltage V3 resulting from amplifying a voltage commensurate with the alternating-current voltage V_{MULT} and the voltage V_{DC}. That is, the calculation circuit 710 generates the third voltage V3 resulting from amplifying a voltage commensurate with the voltage V_{DC}.

The third voltage V3 is connected to the inverting input terminal of the comparator 712. The cathode of the Zener diode 711 is connected to the inverting input terminal of the comparator 712, and the anode of the Zener diode 711 is connected to the ground potential. The Zener diode 711 clamps the third voltage V3 at the Zener voltage.

The comparator 712 compares the slope voltage V_{CS}, which is commensurate with the current passing through the switching transistor M1, with the third voltage V3 to output a voltage V_{COMP} indicating the result of the comparison.

The driving circuit DRV1 drives the switching transistor M1 based on the voltage V_{COMP} output from the comparator 712. More specifically, the driving circuit DRV1 turns on and off the switching transistor M1 and, in accordance with the voltage V_{COMP} output from the comparator 712, turns off the switching transistor M1 every time the slope voltage V_{CS} becomes higher than the third voltage V3. That is, the driving circuit DRV1 turns off the switching transistor M1 based on the voltage V_{COMP} output from the comparator 712. The driving circuit DRV1 may have any configuration and may be one employing known technology.

FIG. 2 shows one example of the driving circuit DRV1. The driving circuit DRV1 includes a comparator 713, a one-shot circuit 714, a timer 715, an OR gate 716, a RS flip-flop 717, an AND gate 718, a pre-driver 719, a gate clamp circuit 720, a PMOS (positive-channel MOS) field-effect transistor 721, an NMOS field-effect transistor 722, and a resistor 723.

The comparator 713 is a hysteresis comparator and compares a voltage fed to the terminal ZCD with a threshold voltage to output the result of the comparison to the one-shot circuit 714. If the voltage fed to the terminal ZCD is equal to or higher than the threshold voltage, the output signal of the comparator 713 is at low level and, if the voltage fed to the terminal ZCD is lower than the threshold voltage, the output signal of the comparator 713 is at high level. The comparator 713 shifts the threshold voltage it uses between a fifth threshold voltage V_{TH5} (for example, 0.67 [V]) and a sixth threshold voltage V_{TH6} (for example, 0.9 [V]) in accordance with the level of the output signal of the comparator 713.

The one-shot circuit 714, if the output signal of the comparator 713 turns to high level, supplies a one-shot pulse to the first input terminal of the OR gate 716.

The timer 715 counts a given time and then feeds a high-level signal to the second input terminal of the OR gate 716. The counting by the timer 715 is reset every time the pre-driver 719 receives a high-level signal from the AND gate 718.

The OR gate 716 feeds the OR of the output signals of the one-shot circuit 714 and the timer 715 to the set terminal (S) of the RS flip-flop 717. The reset terminal (R) of the RS flip-flop 717 is fed with the voltage V_{COMP} output from the comparator 712. The output (Q) of the RS flip-flop 717 turns to high level at every positive edge in the voltage fed to the set terminal (S) and turns to low level at every positive edge in the voltage fed to the reset terminal (R).

The AND gate 718 feeds to the pre-driver 719 the AND of the inversion signal of the undervoltage lock out signal UVLO, the output signal of the RS flip-flop 717, the inversion signal of the static overvoltage protection SOVP, the inversion signal of the short-circuit protection signal SP, and the inversion signal of the overheat protection signal TSD.

The pre-driver 719 turns on an off the PMOS field-effect transistor 721 and the NMOS field-effect transistor 722 complementarily based on the output of the AND gate 718.

The source of the PMOS field-effect transistor 721 is connected to the gate clamp circuit 720, and the drain of the PMOS field-effect transistor 721 is connected to the drain of the NMOS field-effect transistor 722, to the terminal OUT, and to one terminal of the resistor 723. The source of the NMOS field-effect transistor 722 is connected to the ground potential and to the other terminal of the resistor 723. The gate clamp circuit 720 generates a voltage at high level that is fed from the supply voltage V_{CC} to the terminal OUT. The gate clamp circuit 720 clamps at a constant voltage the voltage at high level that is fed to the terminal OUT, so that, when the supply voltage V_{CC} rises, the voltage at high level that is fed to the terminal OUT does not exceed the gate-source withstand voltage of the switching transistor M1.

Thus far is the description of the configuration of the PFC circuit 7. Now, the calculation circuit 710 will be described in detail.

<A First Configuration Example of the Calculation Circuit>

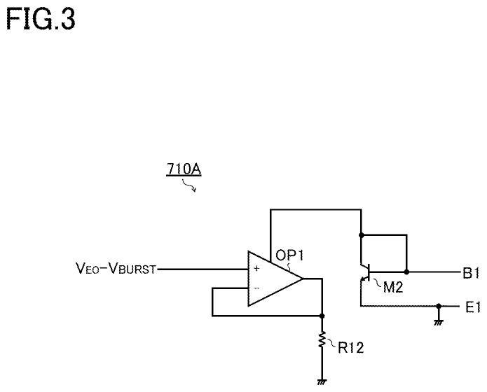

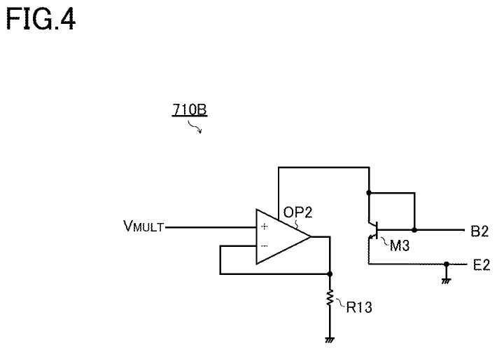

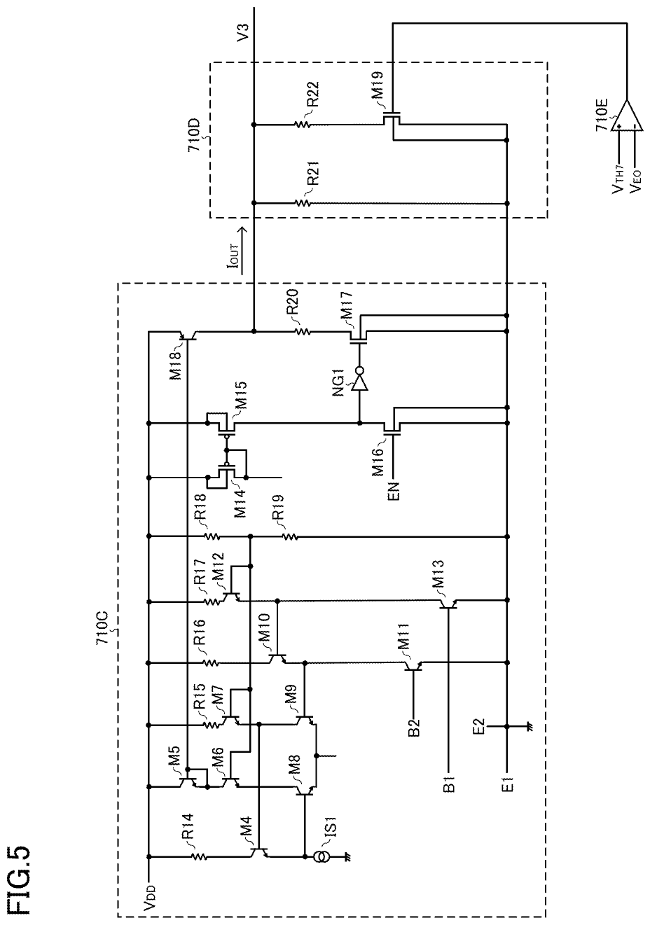

The calculation circuit 710 according to a first configuration example includes a first conversion circuit 710A as shown in FIG. 3, a second conversion circuit 710B as shown in FIG. 4, a current calculator 710C as shown in FIG. 5, a resistor portion 710D, and a comparator 710E.

The first conversion circuit 710A shown in FIG. 3 includes an operational amplifier OP1, a resistor R12, and an NPN bipolar transistor M2. The non-inverting input terminal of the operational amplifier OP1 is fed with a voltage (V_{EO}−V_{BURST}). To the inverting input terminal and the output terminal of the operational amplifier OP1, one terminal of the resistor R12 is connected. To the other terminal of the resistor R12, the ground potential is connected. To the power terminal of the operational amplifier OP1, the collector and the base of the NPN bipolar transistor M2 are connected. The emitter of the NPN bipolar transistor M2 is connected to the ground potential. The first conversion circuit 710A converts the voltage (V_{EO}−V_{BURST}) to a current (I_{EO}−I_{BURST}) and outputs the current (I_{EO}−I_{BURST}) as the base current of the NPN bipolar transistor M2.

The second conversion circuit 710B shown in FIG. 4 includes an operational amplifier OP2, a resistor R13, and an NPN bipolar transistor M3. The non-inverting input terminal of the operational amplifier OP2 is fed with the alternating-current voltage V_{MULT}. To the inverting input terminal and the output terminal of the operational amplifier OP2, one terminal of the resistor R13 is connected. To the other terminal of the resistor R13, the ground potential is connected. To the power terminal of the operational amplifier OP2, the collector and the base of the NPN bipolar transistor M3 are connected. The emitter of the NPN bipolar transistor M3 is connected to the ground potential. The second conversion circuit 710B converts the alternating-current voltage V_{MULT} to a current I_{MULT} and outputs the current I_{MULT} as the base current of the NPN bipolar transistor M3.

The current calculator 710C shown in FIG. 5 includes resistors R14 to R20, a current source IS1, NPN bipolar transistors M4 to M13, PMOS field-effect transistors M14 and M15, NMOS field-effect transistors M16 and M17, a PNP bipolar transistor M18, and an NOT gate NG1.

A constant voltage V_{DD} output from the constant voltage circuit 704 is fed to one terminals of the resistors R14 to R18, to the collector of the NPN bipolar transistor M5, to the source and the back gate of the PMOS field-effect transistor M14, to the source and the back gate of the PMOS field-effect transistor M15, and to the emitter of the PNP bipolar transistor M18. The other terminal of the resistor R14 is connected to the collector of the NPN bipolar transistor M4. The emitter of the NPN bipolar transistor M4 is connected to one terminal of the current source IS1 and to the base of the NPN bipolar transistor M8. The other terminal of the current source IS1 is connected to the ground potential. The base and the emitter of the NPN bipolar transistor M5 are connected to the base of the PNP bipolar transistor M18 and to the collector of the NPN bipolar transistor M6. The emitter of the NPN bipolar transistor M6 is connected to the collector of the NPN bipolar transistor M8. The emitter of the NPN bipolar transistor M8 is connected to the emitter of the NPN bipolar transistor M9. The other terminal of the resistor R15 is connected to the collector of the NPN bipolar transistor M7. The emitter of the NPN bipolar transistor M7 is connected to the base of the NPN bipolar transistor M4 and to the collector of the NPN bipolar transistor M9. The other terminal of the resistor R16 is connected to the collector of the NPN bipolar transistor M10. The emitter of the NPN bipolar transistor M10 is connected to the base of the NPN bipolar transistor M9 and to the collector of the NPN bipolar transistor M11. The emitter of the NPN bipolar transistor M11 is connected to the ground potential. The base of the NPN bipolar transistor M11 is connected to the base and the collector of the NPN bipolar transistor M3 in the second conversion circuit 710B. The NPN bipolar transistors M3 and M11 constitute a current mirror circuit. The other terminal of the resistor R17 is connected to the collector of the NPN bipolar transistor M12. The emitter of the NPN bipolar transistor M12 is connected to the base of the NPN bipolar transistor M10 and to the collector of the NPN bipolar transistor M13. The emitter of the NPN bipolar transistor M13 is connected to the ground potential. The base of the NPN bipolar transistor M13 is connected to the base and the collector of the NPN bipolar transistor M2 in the first conversion circuit 710A. The NPN bipolar transistors M2 and M13 constitute a current mirror circuit. The other terminal of the resistor R18 is connected to one terminal of the resistor R19, to the gate of the NPN bipolar transistor M6, to the gate of the NPN bipolar transistor M7, and to the gate of the NPN bipolar transistor M12. The other terminal of the resistor R19 is connected to the ground potential. The gate and the drain of the PMOS field-effect transistor M14 are connected to the gate of the PMOS field-effect transistor M15. The PMOS field-effect transistors M14 and M15 constitute a current mirror circuit. The drain of the PMOS field-effect transistor M15 is connected to the drain of the NMOS field-effect transistor M16 and to the input terminal of the NOT gate NG1. The gate of the NMOS field-effect transistor M16 is fed with an enable signal EN. The source and the back gate of the NMOS field-effect transistor M16 are connected to the ground potential. The output terminal of the NOT gate NG1 is connected to the gate of the NMOS field-effect transistor M17. The source and the back gate of the NMOS field-effect transistor M17 are connected to the ground potential. The drain of the NMOS field-effect transistor M17 is connected to one terminal of the resistor R20. The other terminal of the resistor R20 is connected to the collector of the PNP bipolar transistor M18.

The current calculator 710C multiplies the current (I_{EO}−I_{BURST}) by the current I_{MULT}, and feeds the output current I_{OUT} resulting from dividing the multiplication result by the current output from the current source IS1 to the resistor portion 710D.

The resistor portion 710D includes resistors R21 and R22 and an NMOS field-effect transistor M19. One terminals of the resistors R21 and R22 are connected to the collector of the PNP bipolar transistor M18 and to the other terminal of the resistor R20. The other terminal of the resistor R21 is connected to the ground potential. The other terminal of the resistor R22 is connected to the drain of the NMOS field-effect transistor M19. The source and the back gate of the NMOS field-effect transistor M19 are connected to the ground potential.

The resistor portion 710D converts the output current I_{OUT} to a voltage K×V_{MULT}×(V_{EO}−V_{BURST}). The gain K is determined by the ratio of the resistance value of the resistor R12 in the first conversion circuit 710A to the resistance value of the resistor portion 710D and by the ratio of the resistance value of the resistor R13 in the second conversion circuit 710B to the resistance value of the resistor portion 710D. The current output from the current source IS1 in the current calculator 710C is proportional to the peak value (maximum value) of the voltage V_{MULT}. The current calculator 710C can be switched, with the enable signal EN, between an enabled state and a disabled state.

The resistance value of the resistor portion 710D and hence the gain K is switched in two steps by the turning on and off of the NMOS field-effect transistor M19. When the NMOS field-effect transistor M19 is off, the resistance value of the resistor portion 710D equals the resistance value of the resistor R21. By contrast, when the NMOS field-effect transistor M19 is on, the resistance value of the resistor portion 710D equals the combined resistance value of the resistors R21 and R22. Accordingly, the gain K with the NMOS field-effect transistor M19 on is lower than that with the NMOS field-effect transistor M19 off.

The gate of the NMOS field-effect transistor M19 is connected to the output terminal of the comparator 710E. A seventh threshold voltage V_{TH7} (for example, 0.9 [V]) is fed to the non-inverting input terminal of the comparator 710E, and the second voltage V_{EO} is fed to the inverting input terminal of the comparator 710E.

When the load power of the DC-DC converter included in the PFC circuit 7 is high, the voltage V_{S} is low and the second voltage V_{EO} is high. By contrast, when the load power of the DC-DC converter included in the PFC circuit 7 is low, the voltage V_{S} is high and the second voltage V_{EO} is low. Thus, the resistance value of the resistor portion 710D and hence the gain K is adjusted in accordance with the load power of the DC-DC converter included in the PFC circuit 7. Specifically, the gain K with a low load power of the DC-DC converter in the PFC circuit 7 is lower than the gain K with a high load power of the DC-DC converter in the PFC circuit 7.

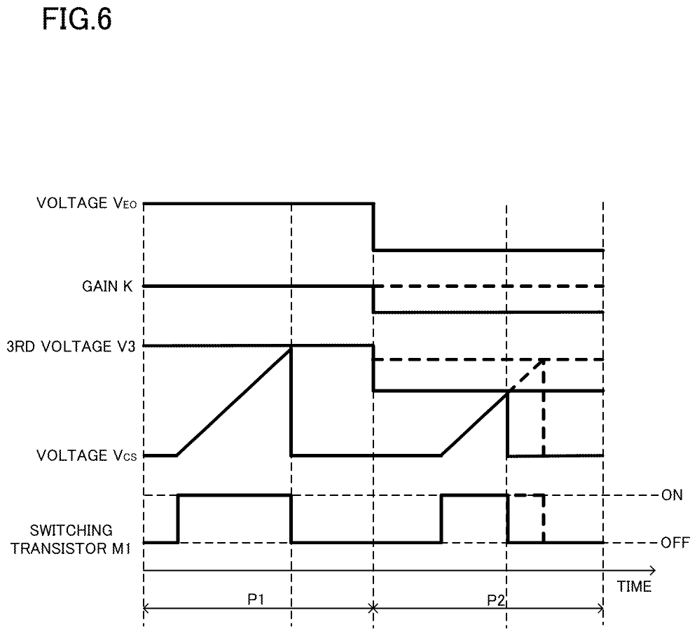

FIG. 6 is a timing chart showing the relevant voltage waveforms in the IC 700 having a calculation circuit 710 according to the first configuration example. The first period P1 is a period during which the load power of the DC-DC converter included in the PFC circuit 7 is high and the NMOS field-effect transistor M19 is off. The second period P2 is a period during which the load power of the DC-DC converter included in the PFC circuit 7 is low and the NMOS field-effect transistor M19 is on. The bold broken lines in the second period P2 represent a comparative example in which the resistance value of the resistor portion 710D is fixed at the resistance value of the resistor R21.

The IC 700 increases the gain K when the load power of the DC-DC converter included in the PFC circuit 7 is high. Thus, the PFC circuit 7 can output high electric power.

The IC 700 decreases the gain K when the load power of the DC-DC converter included in the PFC circuit 7 is low. Thus, the on-period of the switching transistor M1 is shorter, and switching proceeds without being interrupted by burst operation, with lower THD. That is, the IC 700 can lower the THD observed when the PFC circuit 7 outputs low electric power.

<A Second Configuration Example of the Calculation Circuit>

The calculation circuit 710 according to a second configuration example includes, like the calculation circuit 710 according to the first configuration example, a first conversion circuit 710A as shown in FIG. 3, a second conversion circuit 710B as shown in FIG. 4, and a current calculator 710C as shown in FIG. 5. In the calculation circuit 710 according to the second configuration example, the configuration of the stage succeeding the current calculator 710C is different from that in the calculation circuit 710 according to the first configuration example.

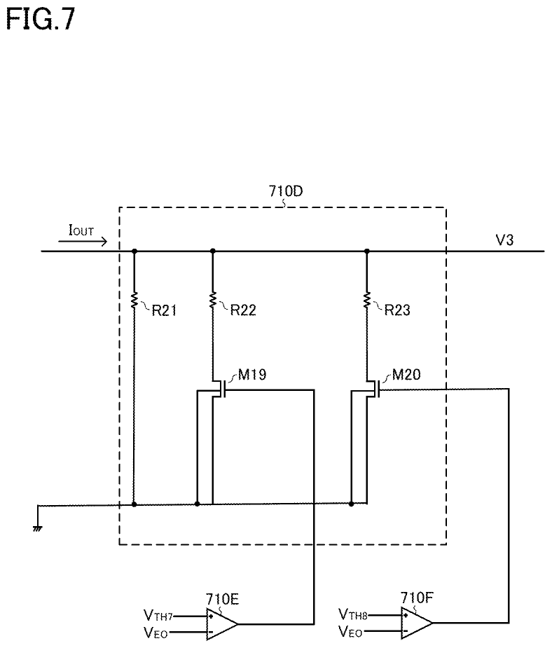

FIG. 7 is a diagram showing a configuration of a part of the calculation circuit 710 according to the second configuration example. The calculation circuit 710 according to the second configuration example includes in the stage succeeding the current calculator 710C a resistor portion 710D and comparators 710E and 710F.

The resistor portion 710D includes resistors R21 to R23 and NMOS field-effect transistors M19 and M20. One terminals of the resistors R21 to R23 are connected to the collector of the PNP bipolar transistor M18 and to the other terminal of the resistor R20 (see FIG. 5). The other terminal of the resistor R21 is connected to the ground potential. The other terminal of the resistor R22 is connected to the drain of the NMOS field-effect transistor M19. The other terminal of the resistor R23 is connected to the drain of the NMOS field-effect transistor M20. The sources and the back gates of the NMOS field-effect transistors M19 and M20 are connected to the ground potential.

The comparator 710E turns on an off the NMOS field-effect transistor M19. The non-inverting input terminal of the comparator 710E is fed with the seventh threshold voltage V_{TH7}, and the inverting input terminal of the comparator 710E is fed with the second voltage V_{EO}. The comparator 710F turns on an off the NMOS field-effect transistor M20. The non-inverting input terminal of the comparator 710F is fed with an eighth threshold voltage V_{TH8}, and the inverting input terminal of the comparator 710F is fed with the second voltage V_{EO}.

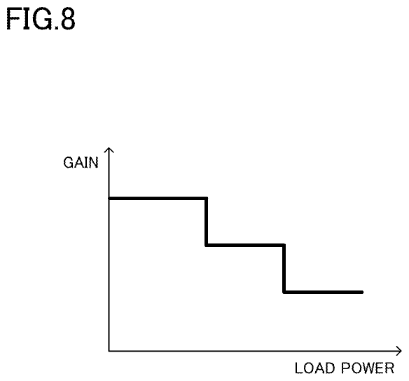

FIG. 8 is a diagram showing the gain characteristics of the calculation circuit 710 according to the second configuration example. As shown in FIG. 8, in accordance with the load power of the DC-DC converter included in the PFC circuit 7, the gain K is switched in three steps by the turning on and off of the NMOS field-effect transistors M19 and M20. The calculation circuit 710 according to the second configuration example can adjust the gain K more finely than the calculation circuit 710 according to the first configuration example. In a modified version of the first and this configuration examples, the gain K can be switched in four or more steps.

<A Third Configuration Example of the Calculation Circuit>

The calculation circuit 710 according to a third configuration example includes, like the calculation circuit 710 according to the first configuration example, a first conversion circuit 710A as shown in FIG. 3, a second conversion circuit 710B as shown in FIG. 4, and a current calculator 710C as shown in FIG. 5. In the calculation circuit 710 according to the third configuration example, the configuration of the stage succeeding the current calculator 710C is different from that in the calculation circuit 710 according to the first configuration example.

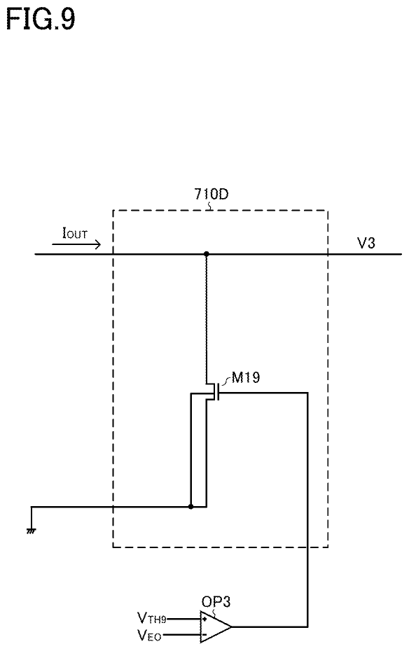

FIG. 9 is a diagram showing a configuration of a part of the calculation circuit 710 according to the third configuration example. The calculation circuit 710 according to the third configuration example includes a resistor portion 710D and an operational amplifier OP3 in the stage succeeding the current calculator 710C.

The resistor portion 710D includes an NMOS field-effect transistor M19. The drain of the NMOS field-effect transistor M19 is connected to the collector of the PNP bipolar transistor M18 and to the other terminal of the resistor R20 (see FIG. 5). The source and the back gate of the NMOS field-effect transistor M19 are connected to the ground potential.

The operational amplifier OP3 performs linear control on the on-resistance of the NMOS field-effect transistor M19. The non-inverting input terminal of the operational amplifier OP3 is fed with a ninth threshold voltage V_{TH9}, and the inverting input terminal of the operational amplifier OP3 is fed with the second voltage V_{EO}.

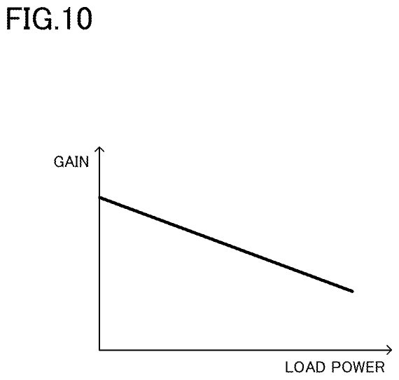

FIG. 10 is a diagram showing the gain characteristics of the calculation circuit 710 according to the third configuration example. As shown in FIG. 10, in accordance with the load power of the DC-DC converter included in the PFC circuit 7, the gain K changes linearly. The calculation circuit 710 according to the third configuration example can adjust the gain K more smoothly (continuously) than the calculation circuits 710 according to the first and second configuration examples.

<Others>

The present invention can be implemented in any other manners than as in the embodiments described above, with any modifications made without departure from the spirit of the invention. The embodiments disclosed herein should be considered to be in every aspect illustrative and not restrictive, and the technical scope of the present invention is defined not by the description of embodiments given above but by the scope of the appended claims and should be understood to encompass any modifications within a sense and scope equivalent to the claims.

For example, although, in the embodiments described above, the gain of the calculation circuit 710 is adjusted in accordance with the load power of the DC-DC converter included in the PFC circuit 7; instead of the gain of the calculation circuit 710, or, in addition to the gain of the calculation circuit 710, the gradient of the slope voltage V_{SLP} may be adjusted in accordance with the load power of the DC-DC converter included in the PFC circuit 7. Specifically, when the load power of the DC-DC converter included in the PFC circuit 7 is low, the gradient of the slope voltage V_{SLP} can be increased. In one example of the configuration that adjusts the gradient of the slope voltage V_{SLP}, the IC 700 incorporates a capacitor and a switch for electrically connecting and disconnecting the capacitor and the terminal CS to and from each other.

According to one aspect of what is disclosed herein, a control circuit (700) for a power factor correction circuit having a DC-DC converter includes an amplifier (710) configured to amplify a voltage commensurate with the output voltage of the DC-DC converter, a comparator (712) configured to compare the output voltage of the amplifier with a slope voltage commensurate with the current passing through a switching element in the DC-DC converter, and a driver (DRV1) configured to drive the switching element (M1) based on the output voltage of the comparator. The control circuit may be configured to adjust at least one of the gain of the amplifier and the gradient of the slope voltage in accordance with the load power of the DC-DC converter. (A first configuration.)

The control circuit according to the first configuration described above can keep THD low when the power factor correction circuit outputs low electric power.

In the control circuit according to the first configuration described above, preferably, the driver is configured to, when the load power of the DC-DC converter is within a predetermined range, suspend switching operation of the switching element. (A second configuration.)

The control circuit according to the second configuration described above can, when the load of the power factor correction circuit is light, suppress a rise in the output voltage of the DC-DC converter.

In the control circuit according to the first or second configuration described above, preferably, the gain of the amplifier is adjusted in accordance with the load power of the DC-DC converter, and the gain can be switched in two steps. (A third configuration.)

The control circuit according to the third configuration described above can adjust the gain of the amplifier with a simple circuit configuration.

In the control circuit according to the first or second configuration described above, preferably, the gain of the amplifier is adjusted in accordance with the load power of the DC-DC converter, and the gain can be switched in three or more steps. (A fourth configuration.)

The control circuit according to the fourth configuration described above can finely adjust the gain of the amplifier.

In the control circuit according to the first or second configuration described above, preferably, the gain of the amplifier is adjusted in accordance with the load power of the DC-DC converter, and the gain can change linearly. (A fifth configuration.)

The control circuit according to the fifth configuration described above can continuously adjust the gain of the amplifier.

In the control circuit according to any of the third to fifth configuration described above, preferably, the amplifier includes a current generator (710 to 710C) configured to generate a current commensurate with the output voltage of the error amplifier and a resistor portion (R21, R22, M18) configured to convert the output current of the current generator into a voltage. The resistance value of the resistor portion may change in accordance with the load power of the DC-DC converter. (A sixth configuration.)

In the control circuit according to the sixth configuration described above, the gain of the amplifier is determined by the resistance value of the resistor portion; thus, it is easy to adjust the gain of the amplifier.

In the control circuit according to the sixth configuration described above, preferably, the resistance value of the resistor portion changes in accordance with the output voltage of the error amplifier (A seventh configuration.)

The control circuit according to the seventh configuration described above can adjust the gain of the amplifier in accordance with the load power of the DC-DC converter with a simple circuit configuration.

According to another aspect of what is disclosed herein, a power factor correction circuit (7) includes the control circuit according to any of the first to seventh configurations described above and the DC-DC converter. (An eighth configuration.)

The power factor correction circuit according to the eighth configuration described above can keep THD low during low power output.

According to yet another aspect of what is disclosed herein, an electronic appliance (1) includes a rectification circuit configured to perform full-wave rectification on an alternating-current voltage and the power factor correction circuit according to the eighth configuration described above configured to receive the output voltage of the rectification circuit. (A ninth configuration.)

The electric appliance according to the ninth configuration described above can keep THD low when a power factor correction circuit outputs low electric power.

What is claimed is:

1. A control circuit for a power factor correction circuit including a DC-DC converter, comprising:
an amplifier configured to amplify a voltage commensurate with an output voltage of the DC-DC converter;
a comparator configured to compare an output voltage of the amplifier with a slope voltage commensurate with a current passing through a switching element in the DC-DC converter; and
a driver configured to drive the switching element based on an output voltage of the comparator,
wherein
the control circuit is configured to adjust at least one of a gain of the amplifier and a gradient of the slope voltage in accordance with a load power of the DC-DC converter.

2. The control circuit according to claim 1,
wherein
the driver is configured to, when the load power of the DC-DC converter is within a predetermined range, suspend switching operation of the switching element.

3. The control circuit according to claim 1,
wherein
the gain of the amplifier is adjusted in accordance with the load power of the DC-DC converter, and
the gain is switchable in two steps.

4. The control circuit according to claim 1,
wherein
the gain of the amplifier is adjusted in accordance with the load power of the DC-DC converter, and
the gain is switchable in three or more steps.

5. The control circuit according to claim 1,
wherein
the gain of the amplifier is adjusted in accordance with the load power of the DC-DC converter, and
the gain is changeable linearly.

6. The control circuit according to claim 3,
wherein
the amplifier includes
a current generator configured to generate a current commensurate with an output voltage of an error amplifier configured to amplify a difference between a voltage commensurate with the output voltage of the DC-DC converter and a reference voltage and
a resistor portion configured to convert an output current of the current generator into a voltage, and
a resistance value of the resistor portion changes in accordance with the load power of the DC-DC converter.

7. The control circuit according to claim 4,
wherein
the amplifier includes
a current generator configured to generate a current commensurate with an output voltage of an error amplifier configured to amplify a difference between a voltage commensurate with the output voltage of the DC-DC converter and a reference voltage and
a resistor portion configured to convert an output current of the current generator into a voltage, and
a resistance value of the resistor portion changes in accordance with the load power of the DC-DC converter.

8. The control circuit according to claim 5,
wherein
the amplifier includes
a current generator configured to generate a current commensurate with an output voltage of an error amplifier configured to amplify a difference between a voltage commensurate with the output voltage of the DC-DC converter and a reference voltage and
a resistor portion configured to convert an output current of the current generator into a voltage, and
a resistance value of the resistor portion changes in accordance with the load power of the DC-DC converter.

9. The control circuit according to claim 6,
wherein
the resistance value of the resistor portion changes in accordance with the output voltage of the error amplifier.

10. A control circuit according to claim 7,
wherein
the resistance value of the resistor portion changes in accordance with the output voltage of the error amplifier.

11. The control circuit according to claim 8,
wherein
the resistance value of the resistor portion changes in accordance with the output voltage of the error amplifier.

12. A power factor correction circuit comprising:
the control circuit according to claim 1; and
the DC-DC converter.

13. An electronic appliance comprising:
a rectification circuit configured to perform full-wave rectification on an alternating-current voltage; and
the power factor correction circuit according to claim 12 configured to receive an output voltage of the rectification circuit.
